(19) United States
(12) Patent Application Publication
(10) Pub. No.: US 2008/0062919 A1
(43) Pub. Date: Mar. 13, 2008

(54) Methods and apparatus for providing a channel avoidance system for a platform with a plurality of wireless communication devices

(76) Inventors: Camille C. Chen, Cupertino, CA (US); Kristoffer D. Fleming, Chandler, AZ (US); Jingyi Ma, Beijing (CN); Xu (Sunny) Zhang, Beijing (CN)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/499,350

(22) Filed: Aug. 4, 2006

(51) Int. Cl. H04Q 7/00; H04Q 7/28

(52) U.S. Cl. 370/329; 370/310; 370/331; 370/341

(57) ABSTRACT

Embodiments of methods and apparatus for providing a channel avoidance system for a platform with a plurality of wireless communication devices are generally described herein. Other embodiments may be described and claimed.

### TECHNICAL FIELD

The present disclosure relates generally to wireless communication systems, and more particularly, to methods and apparatus for providing a channel avoidance system for a platform with a plurality of wireless communication devices.

### BACKGROUND

As wireless communication becomes more and more popular at offices, homes, schools, etc., different wireless technologies and applications may work in tandem to meet the demand for computing and communications at anytime and/or anywhere. For example, a variety of wireless communication networks may coexist to provide a wireless environment with more computing and/or communication capability, greater mobility, and/or eventually seamless roaming.

In particular, wireless personal area networks (WPANs) may offer fast, short-distance connectivity within a relatively small space such as an office workspace or a room within a home. Wireless local area networks (WLANs) may provide broader range than WPANs within office buildings, homes, schools, etc. Wireless metropolitan area networks (WMANs) may cover a greater distance than WLANs by connecting, for example, buildings to one another over a broader geographic area. Wireless wide area networks (WWANs) may provide the broadest range as such networks are widely deployed in cellular infrastructure. Although each of the above-mentioned wireless communication networks may support different usages, coexistence among these networks may provide a more robust environment with anytime and anywhere connectivity.

### BRIEF DESCRIPTION OF THE DRAWINGS

FIG. 1 is a schematic diagram representation of an example wireless communication system according to an embodiment of the methods and apparatus disclosed herein.

FIG. 2 is a block diagram representation of an example platform with a plurality of wireless communication devices.

FIG. 3 depicts an example frequency spectrum associated with the example platform of FIG. 2.

FIG. 4 is a block diagram representation of an example wireless communication device of FIG. 2.

FIG. 5 depicts one manner in which the example platform of FIG. 2 may be configured to provide a channel avoidance system.

FIG. 6 depicts another manner in which the example platform of FIG. 2 may be configured to provide a channel avoidance system.

FIG. 7 depicts yet another manner in which the example platform of FIG. 2 may be configured to provide a channel avoidance system.

FIG. 8 is a block diagram representation of an example processor system that may be used to implement the example platform of FIG. 2.

### DETAILED DESCRIPTION

In general, methods and apparatus for providing a channel avoidance system for a platform with a plurality of wireless communication devices are described herein. The methods and apparatus described herein are not limited in this regard.

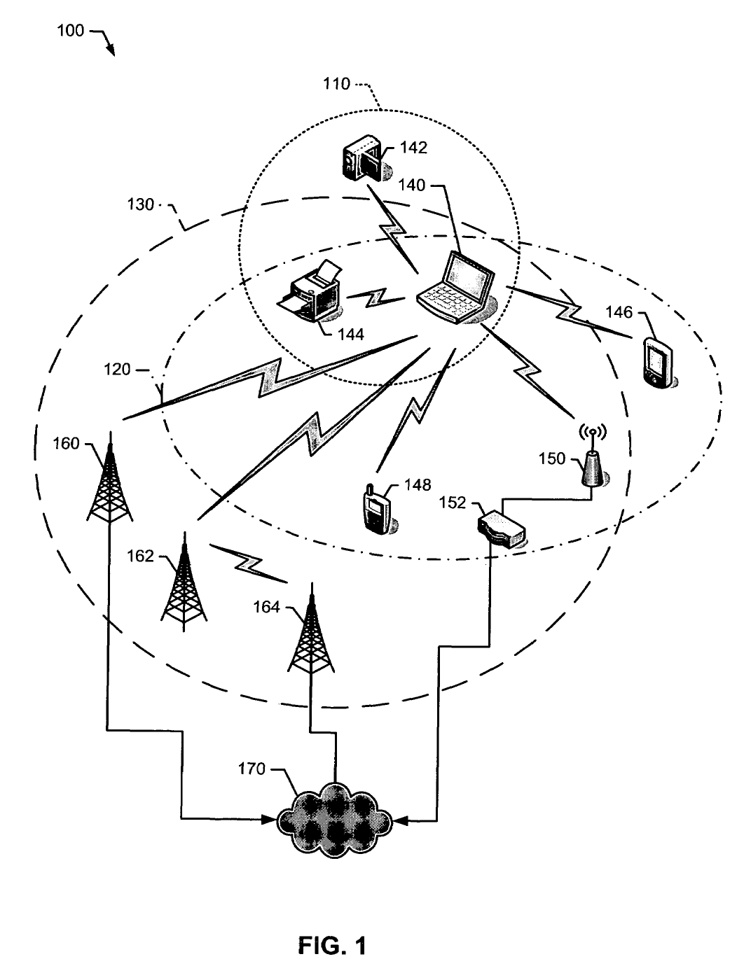

Referring to FIG. 1, an example wireless communication system 100 may include one or more wireless communication networks, generally shown as 110, 120, and 130. In particular, the wireless communication system 100 may include a wireless personal area network (WPAN) 110, a wireless local area network (WLAN) 120, and a wireless metropolitan area network (WMAN) 130. Although FIG. 1 depicts three wireless communication networks, the wireless communication system 100 may include additional or fewer wireless communication networks. For example, the wireless communication networks 100 may include additional WPANs, WLANs, and/or WMANs. The methods and apparatus described herein are not limited in this regard.

The wireless communication system 100 may also include one or more subscriber stations, generally shown as 140, 142, 144, 146, and 148. For example, the subscriber stations 140, 142, 144, 146, and 148 may include wireless electronic devices such as a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and/or other suitable fixed, portable, or mobile electronic devices. Although FIG. 1 depicts five subscriber stations, the wireless communication system 100 may include more or less subscriber stations.

The subscriber stations 140, 142, 144, 146, and 148 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation (e.g., orthogonal frequency-division multiple access (OFDMA)), multi-carrier modulation (MDM), and/or other suitable modulation techniques to communicate via wireless links. In one example, the laptop computer 140 may operate in accordance with suitable wireless communication protocols that require very low power such as Bluetooth®, ultra-wide band (UWB), and/or radio frequency identification (RFID) to implement the WPAN 110. In particular, the laptop computer 140 may communicate with devices associated with the WPAN 110 such as the video camera 142 and/or the printer 144 via wireless links.

In another example, the laptop computer 140 may use direct sequence spread spectrum (DSSS) modulation and/or frequency hopping spread spectrum (FHSS) modulation to implement the WLAN 120 (e.g., the 802.11 family of standards developed by the Institute of Electrical and Electronic Engineers (IEEE) and/or variations and evolutions of these standards). For example, the laptop computer 140 may communicate with devices associated with the WLAN 120 such as the printer 144, the handheld computer 146 and/or the smart phone 148 via wireless links. The laptop computer 140 may also communicate with an access point (AP) 150 via a wireless link. The AP 150 may be operatively coupled to a router 152 as described in further detail below. Alternatively, the AP 150 and the router 152 may be integrated into a single device (e.g., a wireless router).

The laptop computer 140 may use OFDM modulation to transmit large amounts of digital data by splitting a radio frequency signal into multiple small sub-signals, which in turn, are transmitted simultaneously at different frequencies. In particular, the laptop computer 140 may use OFDM modulation to implement the WMAN 130. For example, the laptop computer 140 may operate in accordance with the 802.16 family of standards developed by IEEE to provide for fixed, portable, and/or mobile broadband wireless access (BWA) networks (e.g., the IEEE std. 802.16-2004 (published Sep. 18, 2004), the IEEE std. 802.16e (published Feb. 28, 2006), the IEEE std. 802.16f (published Dec. 1, 2005), etc.) to communicate with base stations, generally shown as 160, 162, and 164, via wireless link(s).

Although some of the above examples are described above with respect to standards developed by IEEE, the methods and apparatus disclosed herein are readily applicable to many specifications and/or standards developed by other special interest groups and/or standard development organizations (e.g., Multi-Band OFDM Alliance (MBOA), WiMedia Alliance, Wireless Fidelity (Wi-Fi) Alliance, Worldwide Interoperability for Microwave Access (WiMAX) Forum, Infrared Data Association (IrDA), Third Generation Partnership Project (3GPP), etc.). The methods and apparatus described herein are not limited in this regard.

The WLAN 120 and WMAN 130 may be operatively coupled to a common public or private network 170 such as the Internet, a telephone network (e.g., public switched telephone network (PSTN)), a local area network (LAN), a cable network, and/or another wireless network via connection to an Ethernet, a digital subscriber line (DSL), a telephone line, a coaxial cable, and/or any wireless connection, etc. In one example, the WLAN 120 may be operatively coupled to the common public or private network 170 via the AP 150 and/or the router 152. In another example, the WMAN 130 may be operatively coupled to the common public or private network 170 via the base station(s) 160, 162, and/or 164.

The wireless communication system 100 may include other suitable wireless communication networks. For example, the wireless communication system 100 may include a wireless wide area network (WWAN) (not shown). The laptop computer 140 may operate in accordance with other wireless communication protocols to support a WWAN. In particular, these wireless communication protocols may be based on analog, digital, and/or dual-mode communication system technologies such as Global System for Mobile Communications (GSM) technology, Wideband Code Division Multiple Access (WCDMA) technology, General Packet Radio Services (GPRS) technology, Enhanced Data GSM Environment (EDGE) technology, Universal Mobile Telecommunications System (UMTS) technology, standards based on these technologies, variations and evolutions of these standards, and/or other suitable wireless communication standards. Although FIG. 1 depicts a WPAN, a WLAN, and a WMAN, the wireless communication system 100 may include other combinations of WPANs, WLANs, WMANs, and/or WWANs. The methods and apparatus described herein are not limited in this regard.

The wireless communication system 100 may include other WPAN, WLAN, WMAN, and/or WWAN devices (not shown) such as network interface devices and peripherals (e.g., network interface cards (NICs)), access points (APs), redistribution points, end points, gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. Although certain examples have been described above, the scope of coverage of this disclosure is not limited thereto.

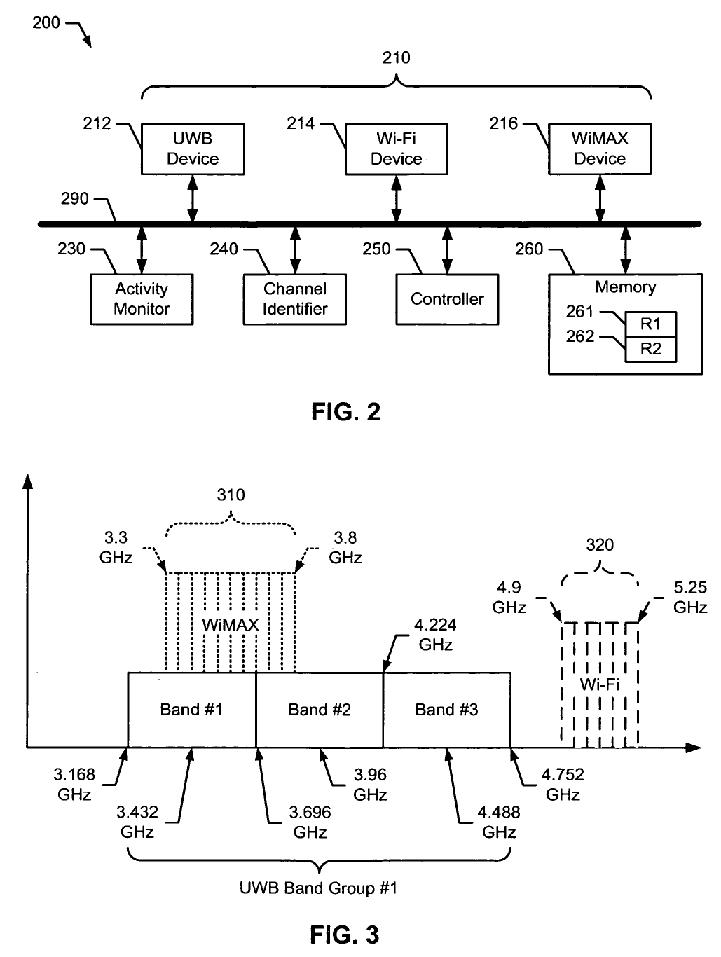

In the example of FIG. 2, a platform 200 may include a plurality of wireless communication devices 210, generally shown as 212, 214, and 216. The platform 200 may also include an activity monitor 230, a channel identifier 240, a controller 250, and a memory 260. The plurality of wireless communication devices 210, the activity monitor 230, the channel identifier 240, the controller 250, and the memory 260 may be operatively coupled to each other via a bus 290. Although FIG. 2 depicts components of the platform 200 coupling to each other via the bus 290, these components may be operatively coupled to each other via other suitable direct or indirect connections (e.g., a point-to-point connection or a point-to-multiple point connection). The platform 200 may be integrated into a single platform such as a subscriber station (e.g., the laptop 140 of FIG. 1).

Each of the plurality of wireless communication devices 210 may be associated with a wireless communication network such as a WPAN, a WLAN, a WMAN, or a WWAN. As noted above, each type of wireless communication network may operate based on a particular wireless communication technology. In one example, the platform 200 may include a wireless communication device based on UWB technology (UWB device) 212, a wireless communication device based on Wi-Fi technology (Wi-Fi device) 214, and a wireless communication device based on WiMAX technology (WiMAX device) 216.

Although FIG. 2 depicts three wireless communication devices, the methods and apparatus described herein may include additional wireless communication devices. While FIG. 2 depicts a UWB device, a Wi-Fi device, and WiMAX device within the platform 200, the methods and apparatus described herein may include other wireless communication devices that may operate in accordance with other suitable types of wireless communication networks and/or include other combinations of wireless communication devices. In one example, the platform 200 may include a wireless communication device based on Bluetooth® technology as an additional wireless communication device or a substitute wireless communication device. The methods and apparatus described herein are not limited in this regard.

Each technology mentioned above may be useful for various reasons and/or suitable for different environments. Briefly, UWB technology may provide high throughput (e.g., up to 480 Megabit per second (Mbps)) with low power at very short range (e.g., less than 30 feet) such as an office workspace, a room within a home, etc. In particular, UWB technology may deliver multimedia services by allowing, for example, high quality video to be distributed throughout a home. In addition to a home entertainment environment, UWB technology may be suitable for wireless universal serial bus (USB). UWB technology may operate in a frequency range starting at 3.1 Gigahertz (GHz) to 10.7 GHz. UWB technology may operate within one or more of a plurality of band groups (e.g., Band Group #1, Band Group #2, Band Group #3, etc.). Each band group may be divided into sub-bands of 528 Megahertz (MHz). In one example, Band Group #1 may include Band #1, Band #2, and Band #3 as described in detail below and depicted in FIG. 3. In particular, Band #1 may start at 3.168 GHz and end at 3.696 GHz with a center frequency of 3.432 GHz. Band #2 may start at 3.696 GHz and end at 4.224 GHz with a center frequency of 3.960 GHz. Band #3 may start at 4.224 GHz and end at 4.752 GHz with a center frequency of 4.488 GHz. A signal from the UWB device 212 may occupy one of the sub-bands and hop between Band #1, Band #2, and Band #3 based pre-defined hopping sequences (e.g., time-frequency-interleaving (TFI) code).

The 802.15 family of standards were developed by IEEE to provide for WPANs (e.g., IEEE std. 802.15.3a published in 2003, variations, and/or evolutions of this standard). The MBOA and WiMedia Alliance facilitate the deployment of WPANs based on UWB technology. In particular, the MBOA and WiMedia Alliance ensure the compatibility and inter-operability of WPAN equipment.

Wi-Fi technology may provide high-speed wireless connectivity within a range of a wireless access point (e.g., a hotspot) in different locations including homes, offices, cafes, hotels, airports, etc. In particular, Wi-Fi technology may allow a wireless device to connect to a local area network without physically plugging the wireless device into the network when the wireless device is within a range of wireless access point (e.g., within 150 feet indoor or 300 feet outdoors). In one example, Wi-Fi technology may offer high-speed Internet access and/or Voice over Internet Protocol (VoIP) service connection to wireless devices. Wi-Fi technology may operate in a frequency range starting at 2.4 GHz and ending at 2.4835 GHz and/or in a frequency range starting at 4.9 GHz to 5.9 GHz. In one example, IEEE std. 802.11a specifies a first band starting from 5.15 GHz to 5.25 GHz, a second band starting from 5.25 GHz to 5.35 GHz, a third band starting from 5.47 GHz to 5.725 GHz, and a fourth band starting from 5.725 GHz to 5.825 GHz. In another example, IEEE std. 802.11j (published 2004) specifies a band from 4.9 GHz to 5.0 GHz.

The 802.11 family of standards were developed by IEEE to provide for WLANs (e.g., the IEEE std. 802.11a published 1999, the IEEE std. 802.11b published 1999, the IEEE std. 802.11g published 2003, variations, and/or evolutions of these standards). The Wi-Fi Alliance facilitates the deployment of WLANs based on the 802.11 standards. In particular, the Wi-Fi Alliance ensures the compatibility and inter-operability of WLAN equipment. For convenience, the terms “802.11” and “Wi-Fi” may be used interchangeably throughout this disclosure to refer to the IEEE 802.11 suite of air interface standards.

WiMAX technology may provide last-mile broadband connectivity in a larger geographical area than other wireless technology such as Wi-Fi technology. In particular, WiMAX technology may provide broadband or high-speed data connection to various geographical locations where wired transmission may be too costly, inconvenient, and/or unavailable. In one example, WiMAX technology may offer greater range and bandwidth to enable T1-type service to businesses and/or cable/digital subscriber line (DSL)-equivalent access to homes. WiMAX technology may operate in a frequency band ranging from 2 to 11 GHz (e.g., a band from 2.3 to 2.4 GHz, a band from 2.5 to 2.7 GHz, a band from 3.3 to 3.8 GHz, or a band from 4.9 to 5.8 GHz).

The 802.16 family of standards were developed by IEEE to provide for fixed, portable, and/or mobile broadband wireless access networks (e.g., the IEEE std. 802.16-2004 published 2004, the IEEE std. 802.16e published 2006, the IEEE std. 802.16f published 2005, variations, and/or evolutions of these standards). The WiMAX Forum facilitates the deployment of broadband wireless access networks based on the IEEE 802.16 standards. In particular, the WiMAX Forum ensures the compatibility and inter-operability of broadband wireless equipment. For convenience, the terms “802.16” and “WiMAX” may be used interchangeably throughout this disclosure to refer to the IEEE 802.16 suite of air interface standards.

Although the plurality of wireless communication devices 210 may operate based on different wireless technologies, two or more of the plurality of wireless communication devices 210 may operate within an identical frequency range, adjacent frequency ranges, overlapping frequency ranges, and/or substantially proximate frequency ranges that may cause interference to and/or be susceptible to interference from each other. In particular, two or more of the plurality of wireless communication devices 210 may operate on channels that may overlap each other. In the example of FIG. 3, the UWB device 212 may operate on a channel in Band #1 (e.g., 3.168 to 3.696 GHz) and/or Band #2 (e.g., 3.696 to 4.224 GHz), which may overlap a channel in a frequency range 310 starting from 3.3 to 3.8 GHz that is used by the WiMAX device 216. Alternatively, two or more of the plurality of wireless communication devices 210 may operate on channels that may be substantially proximate to each other. In one example, the UWB device 212 may operate on a channel in Band #3 (e.g., 4.224 to 4.752 GHz), which may be proximate to a channel within a frequency range 320 starting from 4.9 GHz to 5.25 GHz that is used by the Wi-Fi device 214.

As a result, simultaneous or concurrent use of wireless communication devices based on UWB technology, Wi-Fi technology, and/or WiMAX technology may potentially cause considerable interference. In particular, the interference may be caused by close proximity of frequency, high power transmission, low antenna isolation, and/or requirement of high signal-to-noise ratio for high data rate modulation (e.g., 64 quadrature amplitude modulation (QAM)). In one example, transmission using Wi-Fi technology may affect reception using WiMAX technology or vice versa. To mitigate the potential interference between coexisting UWB technology, Wi-Fi technology and WiMAX technology, the wireless communication devices 210 may be configured to operate as described in detail below.

Briefly, each of the Wi-Fi and WiMAX devices 214 and 216, respectively, may generate a wide band signal, which in turn, may generate side band energy into the pass band of the UWB device 212. Each of the Wi-Fi and WiMAX devices 214 and 216, respectively, may transmit at a substantially higher power level than the UWB device 212. As a result, the side band emission of signals from the Wi-Fi device 214 and 216, respectively, may dominate the noise floor or the received signal at the radio frequency front end of the UWB device 212. The side band emission has a roll-off characteristic with frequency such that energy of the side band emission may decrease as the frequency is further away from the interference signal. As noted above, for example, the UWB device 212 may operate in a sub-band of the Band Group #1. The sub-band closest to the interference signal may be affected the most by side band noise because of frequency roll-off.

Although antenna isolation may reduce interference, the methods and apparatus described herein may further mitigate interference to the UWB device 212 from the Wi-Fi device 214 and/or the WiMAX device 216. As described in detail below, the activity monitor 230 may determine channel information associated with the Wi-Fi device 214 and/or the WiMAX device 216. In particular, the activity monitor 230 may monitor activity of the Wi-Fi device 214 and/or the WiMAX device 216. In particular, the activity monitor 230 may periodically monitor a first register 261 and a second register 262 of the memory 260 for activity information. The first register 261 may include activity information associated with the Wi-Fi device 214. The second register 262 may include activity information associated with the WiMAX device 216. In another example, the UWB device 212 may automatically receive the activity information from the Wi-Fi device 214 and/or the WiMAX device 216. In addition or alternatively, the UWB device 212 may request for the activity information from the Wi-Fi device 214 and/or the WiMAX device 216.

The channel identifier 240 may identify at least one channel associated with one of a plurality of sub-bands of a band group for the UWB device 212 to communicate via a wireless link. In particular, the channel identifier 240 may identify at least one channel in one of the plurality of sub-bands that does not overlap or is not substantially proximate to a frequency range used by the first wireless communication device and/or the second wireless communication device.

Although the components shown in FIG. 2 are depicted as separate blocks within the platform 200, the functions performed by some of these blocks may be integrated within a single semiconductor circuit or may be implemented using two or more separate integrated circuits. In one example, although the activity monitor 230, the channel identifier 240, and the controller 250 are depicted as separate blocks, the activity monitor 230, the channel identifier 240, and/or the controller 250 may be integrated into a single component (e.g., a processor). The methods and apparatus described herein are not limited in this regard.

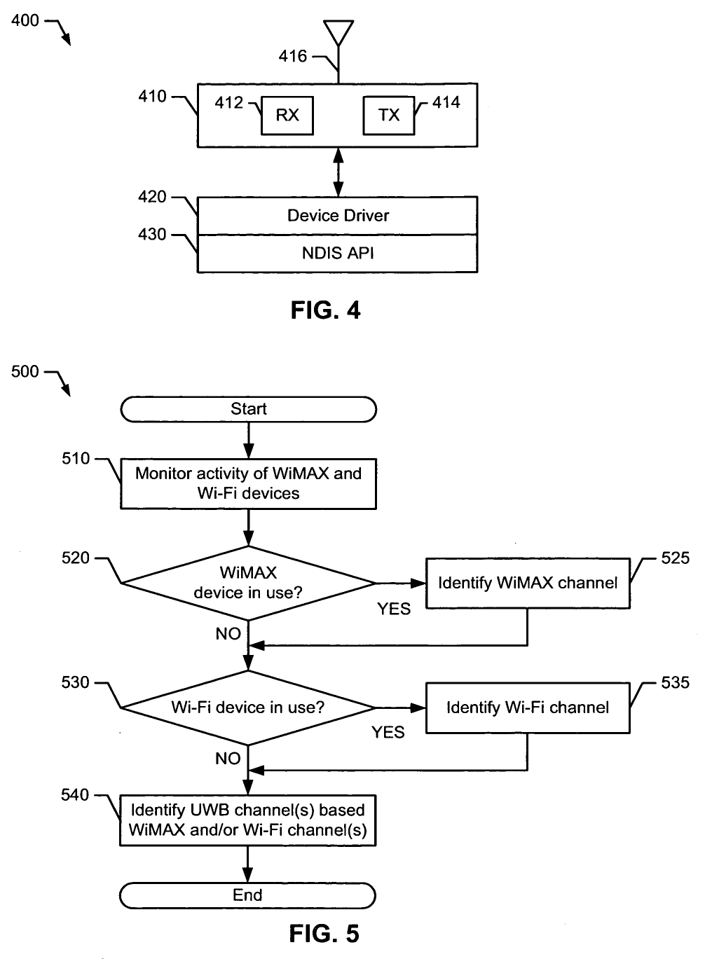

Referring to FIG. 4, for example, a wireless communication device 400 may include network interface device (NID) 410, a device driver 420, and a network device interface specification (NDIS) application program interface (API) 430. The NID 410 may include a receiver (RX) 412 and a transmitter (TX) 414. The NID 410 may be operatively coupled to an antenna 416. The antenna 416 may include one or more directional or omni-directional antennas such as dipole antennas, monopole antennas, patch antennas, loop antennas, microstrip antennas, and/or other types of antennas suitable for transmission of RF signals. Although FIG. 4 depicts a single antenna, the wireless communication device 400 may include additional antennas. For example, the wireless communication device 400 may include a plurality of antennas to implement a multiple-input-multiple-output (MIMO) system.

In general, the functions performed by the activity monitor 230 and/or the channel identifier 240 may be implemented by the NDIS API 430 and/or the device driver 420. In one example, the wireless communication device 400 may be the UWB device 212 (FIG. 2). Accordingly, the NDIS API 430 may determine channel information associated with the Wi-Fi device 214 and the WiMAX device 216. The device driver 420 may identify at least one channel in one of the plurality of sub-bands (e.g., Bands #1, #2, and #3 of FIG. 3) that does not overlap or is not substantially proximate to a frequency range used by the Wi-Fi device 214 and/or the WiMAX device 216. Following the above example, the device driver 420 may identify at least one channel in the Band #1, the Band #2, or the Band #3.

Although the components shown in FIG. 4 are depicted as separate blocks within the wireless communication device 400, the functions performed by some of these blocks may be integrated within a single semiconductor circuit or may be implemented using two or more separate integrated circuits. For example, although the receiver 412 and the transmitter 414 are depicted as separate blocks within the NID 410, the receiver 412 may be integrated into the transmitter 414 (e.g., a transceiver). The methods and apparatus described herein are not limited in this regard.

FIG. 5 depicts one manner in which the platform 200 of FIG. 2 may be configured to provide a channel avoidance system. The example process 500 of FIG. 5 may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a flash memory, a magnetic media, an optical media, and/or any other suitable type of medium.

Further, although a particular order of actions is illustrated in FIG. 5, these actions may be performed in other temporal sequences (e.g., simultaneously or concurrently). Again, the example process 500 is merely provided and described in conjunction with the platform 200 of FIG. 2 as an example of one way to provide a channel avoidance system.

In the example of FIG. 5, the process 500 may begin with the UWB device 212 (e.g., via the activity monitor 230 of FIG. 2) monitoring activities of the Wi-Fi device 214 and the WiMAX device 216 (block 510). In one example, the UWB device 212 may periodically monitor a first register and a second register of the memory 240 (not shown). The first register may include activity information associated with the Wi-Fi device 214. The second register may include activity information associated with the WiMAX device 216. In another example, the UWB device 212 may automatically receive the activity information from the Wi-Fi device 214 and/or the WiMAX device 216. In addition or alternatively, the UWB device 212 may request for the activity information from the Wi-Fi device 214 and/or the WiMAX device 216.

The UWB device 212 may determine whether the WiMAX device 216 is in use (block 520). If the WiMAX device 216 is in use, the UWB device 212 may identify the channel used by the WiMAX device 216 (block 525). The UWB device 212 may also determine whether the Wi-Fi device 214 is in use (block 530). Referring back to block 520, if the WiMAX device 216 is not in use, controls may proceed directly to block 530.

If the Wi-Fi device 214 is in use, the UWB device 212 may identify the channel used by the Wi-Fi device 214 (block 535). Based on the channel(s) used by the WiMAX device 216 and/or the Wi-Fi device 214, the UWB device 212 may determine a channel to use for communication via a wireless link (block 540). Turning back to block 530, if the Wi-Fi device 214 is not in use, controls may proceed directly to block 540. The methods and apparatus described herein are not limited in this regard.

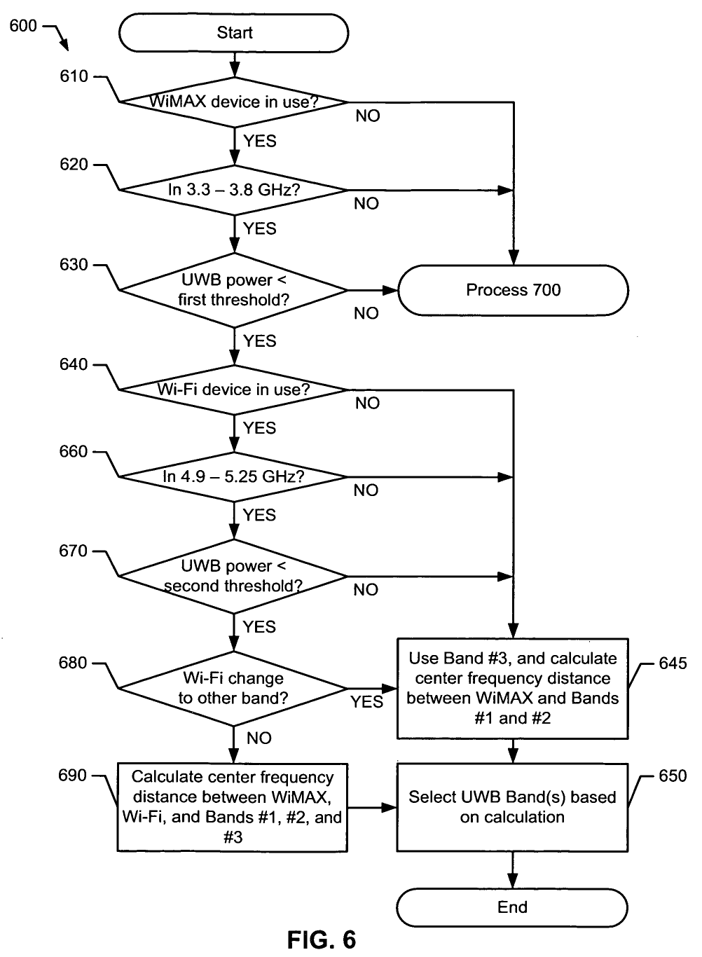

Referring to FIG. 6, for example, the process 600 may begin with the UWB device 212 determining whether the WiMAX device 216 is in use (block 610). If the UWB device 212 determines that the WiMAX device 216 is not in use, controls may proceed to the process 700 as described in detail below. Othewise if the UWB device 212 determines that the WiMAX device 216 is in use at block 610, the UWB device 212 may determine whether WiMAX device 216 is operating in a frequency range of 3.3 GHz to 3.8 GHz (e.g., the frequency range 310 of FIG. 3) (block 620). As depicted in FIG. 3, the frequency range of 3.3 GHz to 3.8 GHz may overlap with the Bands #1 and #2 of the UWB Band Group #1.

If the WiMAX device 216 is not operating in the frequency range of 3.3 GHz to 3.8 GHz, controls may proceed to the process 700 as described in detail below. Otherwise if the WiMAX device 216 is operating in the frequency range of 3.3 GHz to 3.8 GHz, the UWB device 212 may determine whether the power level of the UWB device 212 is less than a first threshold (block 630). In particular, the first threshold may be a pre-defined power level such that the UWB device 212 may disregard interference caused by the WiMAX device 216.

If the UWB power is greater than or equal to the first threshold (e.g., the UWB device 212 may ignore interference caused by the WiMAX device 216), controls may proceed to the process 700 as described in detail below. Otherwise if the power level of the UWB device 212 is less than the first threshold (e.g., the WiMAX device 216 may cause interference to the UWB device 212), the UWB device 212 may determine whether the Wi-Fi device 214 is in use (block 640).

If the Wi-Fi device 214 is not in use, the UWB device 212 may calculate the distance between the center frequencies of the channel associated with WiMAX device 216 and the Band #1, and the distance between the center frequencies of the channel associated with the WiMAX device 216 and the Band #2 (block 645). In addition to using the Band #3, the UWB device 212 may use either the Band #1 or the Band #2 based on the distance calculations to communicate via a wireless link (block 650). In one example, the UWB device 212 may use the UWB band associated with a center frequency farthest away from the center frequency of the channel associated with the WiMAX device 216. Referring back to FIG. 3, for example, the Band #3 may not overlap with the frequency range 310 of the WiMAX device 216 whereas the Bands #1 and #2 may overlap with the frequency range 310 of the WiMAX device 216. Accordingly, the UWB device 212 may use channels in either (1) the Bands #1 and #3, or (2) the Bands #2 and #3 to communicate. As a result, the UWB device 212 may avoid or reduce interference to and/or from the WiMAX device 216.

Turning back to block 640 of FIG. 6, if the Wi-Fi device 214 is in use, the UWB device 212 may determine whether the Wi-Fi device 214 is operating in a frequency range of 4.9 GHz to 5.25 GHz (e.g., the frequency range 320 of FIG. 3) (block 660). If the Wi-Fi device 214 is not operating in the frequency range of 4.9 GHz to 5.25 GHz, the UWB device 212 may proceed to blocks 545 and 550 as described above. Otherwise if the Wi-Fi device 214 is operating in the frequency range of 4.9 GHz to 5.25 GHz, the UWB device 212 may determine whether the power level of the UWB device 212 is less than the second threshold (block 670). In particular; the second threshold may be a pre-defined power level such that the UWB device 212 may disregard interference caused by the Wi-Fi device 214.

If the UWB power is greater than or equal to the second threshold (e.g., the UWB device 212 may ignore interference from the Wi-Fi device 214), controls may proceed to blocks 645 and 650 as described above. Otherwise if the power level of the UWB device 212 is less than the second threshold (e.g., the Wi-Fi device 214 may cause interference to the UWB device 212), the UWB device 212 may determine whether the Wi-Fi device 214 may change to another band (block 680).

If the Wi-Fi device 214 may change to another band, controls may proceed to blocks 645 and 650 as described above. Otherwise if the Wi-Fi device 214 cannot change to another band, the UWB device 212 may calculate the distance between center frequencies of the channel associated with the WiMAX device 216 and of each of the Bands #1, #2, and #3 (block 690). The UWB device 212 may also calculate the distance between center frequencies of the channel associated with the Wi-Fi device 214 and of each of the Bands #1, #2, and #3. Based on the distance calculations mentioned above, the UWB device 212 may use one of the Bands #1, #2, and #3 to communicate via a wireless link (block 650). In one example, the UWB device 212 may use a channel associated with one of the Bands #1, #2, and #3 that may be farthest away from the center frequency of a channel used by the Wi-Fi device 214 and a channel used by the WiMAX device 216. With greater distance between the center frequency of the channel used by the UWB device 212 and the center frequencies of the channels used by the Wi-Fi device 214 and the WiMAX device 216, the UWB device 212 may avoid frequency overlap and/or reduce adjacent spectrum leakage. As a result, the UWB device 212 may avoid or reduce interference from and/or to the Wi-Fi device 214 and/or the WiMAX device 216.

As noted above, the WiMAX device 216 may provide relatively greater range in coverage than either the Wi-Fi device 214 or the UWB device 212. As a result, the WiMAX device 216 may lose more range in coverage than either the Wi-Fi 214 or the UWB device 212 by relatively the same level of interference. Accordingly, platform 200 may give the WiMAX device 216 may greater priority than both the Wi-Fi device 214 and the UWB device 212. Further, the UWB device 212 may use a wider frequency band than the Wi-Fi device 214 (e.g., the frequency band 320 of FIG. 3 has a bandwidth of 350 MHz whereas the UWB Band Group #1 has a bandwidth of 1.584 GHz). Thus, the platform 200 may give greater priority to the Wi-Fi device 214 than the UWB device 212. The methods and apparatus described herein are not limited in this regard.

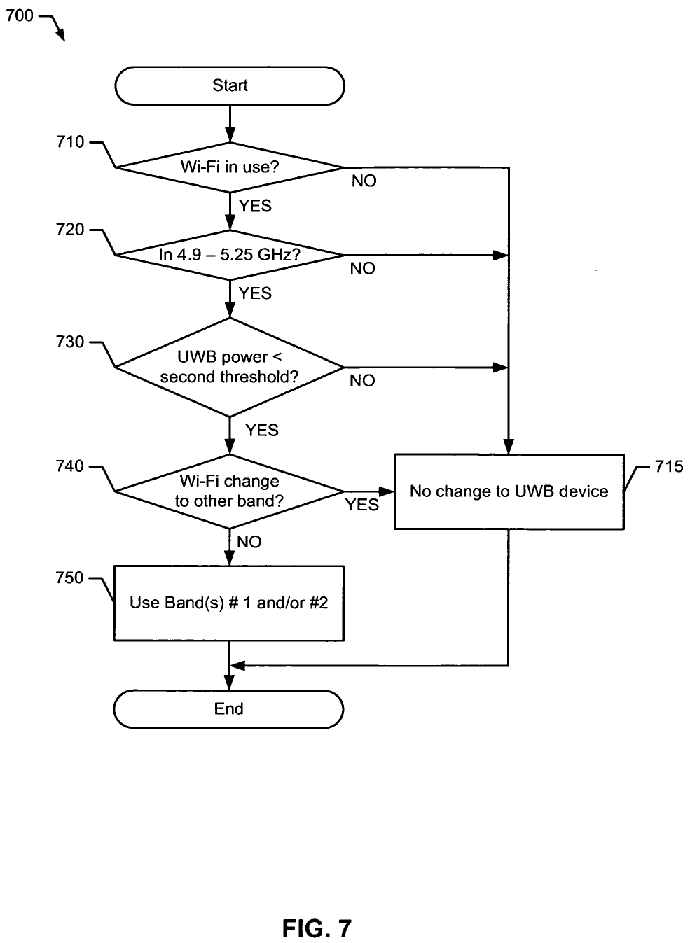

In the example of FIG. 7, the non-interfering WiMAX process 700 may begin with the UWB device 212 determining whether the Wi-Fi device 214 is in use (block 710). If the Wi-Fi device 214 is not in use, the UWB device 212 may continue to communicate via a wireless link without any changes (block 715). In particular, the Wi-Fi device 214 may operate in a band that is not substantially proximate to the Bands #1, #2, and/or #3. As a result, the UWB device 212 and the Wi-Fi device 214 may not cause interference to each other.

Otherwise if the UWB device 212 determines that the Wi-Fi 214 is in use at block 710, the UWB device 212 may determine whether the Wi-Fi device 214 is operating in a frequency range of 4.9 GHz to 5.25 GHz (block 720). If the Wi-Fi device 214 is not operating in the frequency range of 4.9 GHz to 5.25 GHz, controls may proceed to block 715 as described above. Accordingly, the UWB device 212 may continue to communicate via a wireless link without any changes. Otherwise if the Wi-Fi device 214 is operating in the frequency range of 4.9 GHz to 5.25 GHz, the UWB device 212 may determine whether the power level of the UWB device 212 is less than the second threshold (block 730). As noted above, the second threshold may be a pre-defined power level such that the UWB device 212 may disregard interference caused by the Wi-Fi device 214.

If the power level of the UWB device 212 is greater than or equal to the second threshold (e.g., the UWB device 212 may ignore interference from the Wi-Fi device 214), controls may proceed to block 715 as described above. Accordingly, the UWB device 212 may continue to communicate via a wireless link without any changes. Otherwise if the power level of the UWB device 212 is less than the second threshold (e.g., the Wi-Fi device 214 may cause interference to the UWB device 212), the UWB device 212 may determine whether the Wi-Fi device 214 may change to another band (block 740).

If the Wi-Fi device 214 may change to another band, controls may proceed to block 715 as described above. Accordingly, the UWB device 212 may continue to communicate via a wireless link without any changes. Otherwise if the Wi-Fi device 214 cannot change to another band, the UWB device 212 may use the Bands #1 and/or #2 (block 750). As depicted in FIG. 3, for example, the UWB device 212 may avoid the Band #3 because the Band #3 may be substantially proximate to the frequency range 320 used by the Wi-Fi device 214. As a result, the UWB device 212 may avoid or mitigate interference from and/or to the Wi-Fi device 214. The methods and apparatus described herein are not limited in this regard.

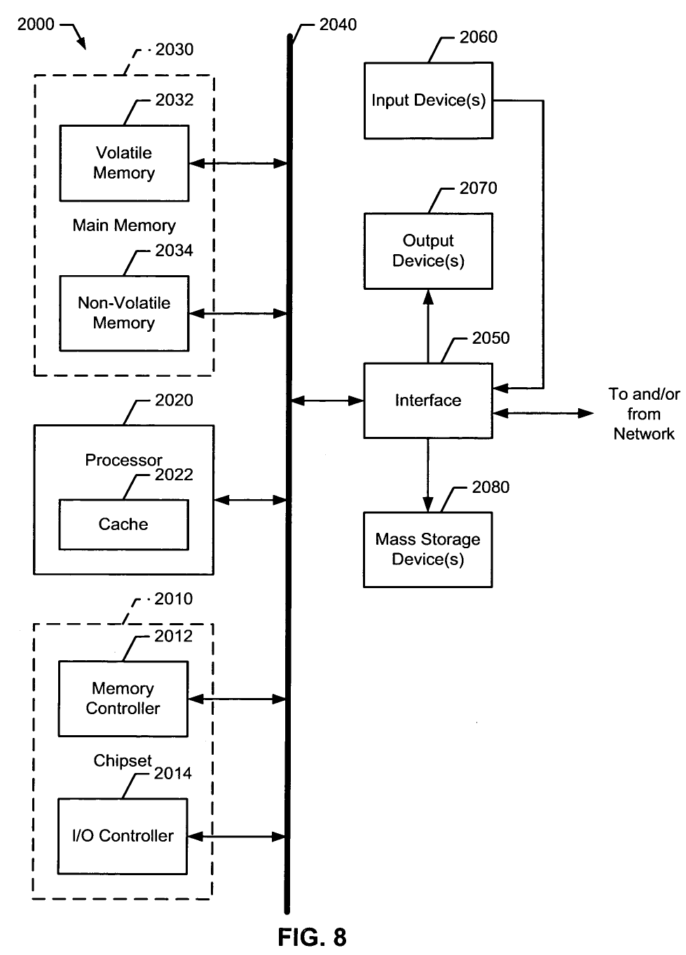

FIG. 8 is a block diagram of an example processor system 2000 adapted to implement the methods and apparatus disclosed herein. The processor system 2000 may be a desktop computer, a laptop computer, a handheld computer, a tablet computer, a personal digital assistant (PDA), a server, an Internet appliance, and/or any other type of computing device.

The processor system 2000 illustrated in FIG. 8 may include a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WPAN components, WLAN components, WMAN components, WWAN components, and/or other suitable processing components. For example, the processor 2020 may be implemented using one or more of the Intel® Core™ technology, the Intel® Pentium® technology, the Intel® Itanium® technology, the Intel® Centrino™ technology, and/or the Intel® Xeon™ technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by synchronous dynamic random access memory (SDRAM), dynamic random access memory (DRAM), RAMBUS dynamic random access memory (RDRAM), static random access memory (SRAM) and/or any other type of random access memory device. The non-volatile memory 2034 may be implemented by flash memory, read only memory (ROM), electrically erasable programmable read only memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 8 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
determining channel information associated with at least one of a first wireless communication device or a second wireless communication device of a plurality of wireless communication devices coexisting and located within a platform, the first wireless communication device being associated with a first wireless communication network and the second wireless communication device being associated with a second wireless communication network; and
identifying at least one channel associated with one of a plurality of sub-bands of a band group for a third wireless communication device of the plurality of wireless communication devices to communicate via a wireless link based on the channel information, the third wireless communication device being associated with a third wireless communication network,
wherein at least one of the plurality of sub-bands overlaps or is substantially proximate to at least one of a frequency range associated with the first wireless communication device or a frequency range associated with the second wireless communication device.

2. A method as defined in claim 1, wherein determining the channel information comprises determining whether at least one of a channel associated with the first wireless communication device or a channel associated with the second wireless communication device is operating in a frequency range that overlaps with or is substantially proximate to at least one of the plurality of sub-bands.

3. A method as defined in claim 1, wherein identifying the at least one channel comprises identifying a channel based on distance between a first center frequency and a second center frequency, wherein the first center frequency is associated with a channel used by the first wireless communication device or the second wireless communication devices, and wherein the second center frequency is associated with a first sub-band, a second sub-band, or a third sub-band of the plurality of sub-bands.

4. A method as defined in claim 1, wherein identifying the at least one channel comprises identifying a channel associated with a first center frequency, the first center frequency being farther away from a second center frequency than a third center frequency, wherein each of the first and third center frequencies is associated with one of the plurality of sub-bands, and wherein the second center frequency is associated with a channel used by the first wireless communication device or a channel used by the second wireless communication device.

5. A method as defined in claim 1, wherein identifying the at least one channel comprises determining whether a receive power of the third wireless communication device is less than a power threshold, the power threshold being based on signal strength of the first wireless communication device or the second wireless communication device.

6. A method as defined in claim 1, wherein identifying the at least one channel comprises identifying a channel associated with any one of the plurality of sub-bands of the band group in response to detecting that the first wireless communication device is operating outside of a first frequency range and the second wireless communication device is operating outside of a second frequency range, wherein the first frequency range overlaps with at least one of the plurality of sub-bands, and wherein the second frequency range is substantially proximate to at least one of the plurality of sub-bands.

7. A method as defined in claim 1 further comprising monitoring activity of at least one of the first wireless communication device or the second wireless communication device to determine the channel information.

8. A method as defined in claim 1 further comprising receiving activity information associated with at least one of the first wireless communication device or the second wireless communication device to determine the channel information, the activity information being indicative of whether the first and second wireless communication devices are in use.

9. A method as defined in claim 1, wherein the first wireless communication device is configured to operate based on Wireless Interoperability for Microwave Access (WiMAX) technology, wherein the second wireless communication device is configured to operate based on Wireless Fidelity (Wi-Fi) technology, and wherein the third wireless communication device is configured to operate based on Ultra-Wide Band (UWB) technology.

10. A method as defined in claim 1, wherein the first wireless communication network comprises a wireless local area network, wherein the second wireless communication network comprises a wireless metropolitan area network, and wherein the third wireless communication network comprises a wireless personal area network.

11. An apparatus comprising:
an activity monitor to determine channel information associated with at least one of a first wireless communication device or a second wireless communication device of a plurality of wireless communication devices coexisting and located within a platform, the first wireless communication device being associated with a first wireless communication network and the second wireless communication device being associated with a second wireless communication network; and
a channel identifier to identify at least one channel associated with one of a plurality of sub-bands of a band group for a third wireless communication device of the plurality of wireless communication devices to communicate via a wireless link based on the channel information, the third wireless communication device being associated with a third wireless communication network,
wherein at least one of the plurality of sub-bands overlaps or is substantially proximate to at least one of a frequency range used by the first wireless communication device or a frequency range used by the second wireless communication device.

12. An apparatus as defined in claim 11, wherein the activity monitor is configured to determine whether at least one of a channel associated with the first wireless communication device or a channel associated with the second wireless communication device is operating in a frequency range that overlaps with or is substantially proximate to at least one of the plurality of sub-bands.

13. An apparatus as defined in claim 11, wherein the channel identifier is configured to identify a channel based on distance between a first center frequency and a second center frequency, wherein the first center frequency is associated with a channel used by the first wireless communication device or the second wireless communication devices, and wherein the second center frequency is associated with a first sub-band, a second sub-band, or a third sub-band of the plurality of sub-bands.

14. An apparatus as defined in claim 11, wherein the channel identifier is configured to identify a channel associated with a first center frequency, the first center frequency being farther away from a second center frequency than a third center frequency, wherein each of the first and third center frequencies is associated with one of the plurality of sub-bands, and wherein the second center frequency is associated with a channel used by the first wireless communication device or a channel used by the second wireless communication device.

15. An apparatus as defined in claim 11, wherein the channel identifier is configured to determine whether a receive power of the third wireless communication device is less than a power threshold, the power threshold being based on signal strength of the first wireless communication device or the second wireless communication device.

16. An apparatus as defined in claim 11, wherein the channel identifier is configured to identify a channel associated with any one of the plurality of sub-bands of the band group in response to detecting that the first wireless communication device is operating outside of a first frequency range and the second wireless communication device is operating outside of a second frequency range, wherein the first frequency range overlaps with at least one of the plurality of sub-bands, and wherein the second frequency range is substantially proximate to at least one of the plurality of sub-bands.

17. An apparatus as defined in claim 11, wherein the activity monitor is configured to monitor activity of at least one of the first wireless communication device or the second wireless communication device to determine the channel information.

18. An article of manufacture including content, which when accessed, causes a machine to:
determine channel information associated with at least one of a first wireless communication device or a second wireless communication device of a plurality of wireless communication devices coexisting and located within a platform, the first wireless communication device being associated with a first wireless communication network and the second wireless communication device being associated with a second wireless communication network; and
identify at least one channel associated with a sub-band of a plurality of sub-bands of a band group for a third wireless communication device of the plurality of wireless communication devices to communicate via a wireless link based on channel information, the third wireless communication device being associated with a third wireless communication network,
wherein the sub-band does not overlap or is not substantially proximate to a frequency range used by at least one of the first wireless communication device or the second wireless communication device.

19. An article of manufacture as defined in claim 18, wherein the content, when accessed, causes the machine to determine the channel information by determining whether at least one of a channel associated with the first wireless communication device or a channel associated with the second wireless communication device is operating in a frequency range that overlaps with or is substantially proximate to at least one of the plurality of sub-bands.

20. An article of manufacture as defined in claim 18, wherein the content, when accessed, causes the machine to identify a channel based on distance between a first center frequency and a second center frequency, wherein the first center frequency is associated with a channel used by the first wireless communication device or the second wireless communication devices, and wherein the second center frequency is associated with a first sub-band, a second sub-band, or a third sub-band of the plurality of sub-bands.

21. An article of manufacture as defined in claim 18, wherein the content, when accessed, causes the machine to identify the at least one channel by identifying a channel associated with a first center frequency, the first center frequency being farther away from a second center frequency than a third center frequency, wherein each of the first and third center frequencies is associated with one of the plurality of sub-bands, and wherein the second center frequency is associated with a channel used by the first wireless communication device or a channel used by the second wireless communication device.

22. An article of manufacture as defined in claim 18, wherein the content, when accessed, causes the machine to determine whether a receive power of the third wireless communication device is less than a power threshold, the power threshold being based on signal strength of the first wireless communication device or the second wireless communication device.

23. An article of manufacture as defined in claim 18, wherein the content, when accessed, causes the machine to identify the at least one channel by identifying a channel associated with any one of the plurality of sub-bands in response to detecting that the first wireless communication device is operating outside of a first frequency range and the second wireless communication device is operating outside of a second frequency range, wherein the first frequency range overlaps with at least one of the plurality of sub-bands, and wherein the second frequency range is substantially proximate to at least one of the plurality of sub-bands.

24. An article of manufacture as defined in claim 18, wherein the content, when accessed, causes the machine to monitor activity of at least one of the first wireless communication device or the second wireless communication device to determine the channel information.

25. A system comprising:
an omni-directional antenna; and
a processor operatively coupled to the antenna to determine channel information associated with at least one of a first wireless communication device or a second wireless communication device of a plurality of wireless communication devices coexisting and located within a platform, and to identify at least one channel associated with a sub-band of a plurality of sub-bands of a band group for a third wireless communication device of the plurality of wireless communication devices to communicate via a wireless link based on channel information,
wherein the first wireless communication device is associated with a first wireless communication network, the second wireless communication device is associated with a second wireless communication network, and the third wireless communication device is associated with a third wireless communication network.

26. A system as defined in claim 25, wherein the processor is configured to determine whether at least one of a channel associated with the first wireless communication device or a channel associated with the second wireless communication device is operating in a frequency range that overlaps with or is substantially proximate to at least one of the plurality of sub-bands.

27. A system as defined in claim 25, wherein the processor is configured to identify a channel based on distance between a first center frequency and a second center frequency, wherein the first center frequency is associated with a channel used by the first wireless communication device or the second wireless communication devices, and wherein the second center frequency is associated with a first sub-band, a second sub-band, or a third sub-band of the plurality of sub-bands.

28. A system as defined in claim 25, wherein the processor is configured to identify a channel associated with a first center frequency, the first center frequency being farther away from a second center frequency than a third center frequency, wherein each of the first and third center frequencies is associated with one of the plurality of sub-bands, and wherein the second center frequency is associated with a channel used by the first wireless communication device or a channel used by the second wireless communication device.

29. A system as defined in claim 25, wherein the processor is configured to determine whether a receive power of the third wireless communication device is less than a power threshold, the power threshold being based on signal strength of the first wireless communication device or the second wireless communication device.

30. A system as defined in claim 25, wherein the processor is configured to identify a channel associated with any one of the plurality of sub-bands in response to detecting that the first wireless communication device is operating outside of a first frequency range and the second wireless communication device is operating outside of a second frequency range, wherein the first frequency range overlaps with at least one of the plurality of sub-bands, and wherein the second frequency range is substantially proximate to at least one of the plurality of sub-bands.
